(19) United States
(12) Patent Application Publication
(10) Pub. No.: US 2024/0202679 A1
(43) Pub. Date: Jun. 20, 2024

(54) Bridging Blockchains

(71) Applicant: Circle Internet Financial, Limited, Boston, MA (US)

(72) Inventors: Walker MAYERCHAK, Somerville, MA (US); Chase MCDERMOTT, Houston, TX (US); Michael GRANT, Walpole, MA (US); Marcus Stern BOORSTIN, Cambridge, MA (US); Erik TIERNEY, Lexington, MA (US); Gee-Hsien CHUANG, Los Gatos, CA (US)

(21) Appl. No.: 18/127,583

(22) Filed: Mar. 28, 2023

Related U.S. Application Data
(60) Provisional application No. 63/432,937, filed on Dec. 15, 2022.

(51) Int. Cl. G06Q 20/06; G06Q 20/38

(52) U.S. Cl. CPC G06Q 20/0658; G06Q 20/3823; G06Q 20/389

(57) ABSTRACT

Certain aspects of the present disclosure provide techniques for performing a blockchain-based transaction, comprising: executing a first process on a first blockchain, including: causing a first amount of cryptocurrency to be burned on the first blockchain according to a burn operation; formatting a message to include one or more details of the burn operation; and emitting the message to an event log associated with the first blockchain; requesting an attestation from an attestation service based on a hash of the message emitted to the event log; receiving the attestation from the attestation service; and executing a second process on a second blockchain, including: providing the message and the attestation to the second blockchain; and causing a second amount of cryptocurrency to be minted on the second blockchain based on the message.

### CROSS REFERENCE TO RELATED APPLICATIONS

The present disclosure claims benefit of U.S. Provisional patent application Ser. No. 63/432,937, filed Dec. 15, 2022, the entirety of which is incorporated by reference herein.

### INTRODUCTION

Aspects of the present disclosure relate to bridging between blockchain networks and therefore enabling data exchange between the blockchain networks.

A blockchain is generally a distributed database or ledger that is shared among nodes of a computer network, and thus is sometimes referred to as a blockchain network. Generally, “chain” or “blockchain” may refer to a blockchain network. Blockchains are generally configured to store information electronically in a digital format, such as the record of ownership of an asset, like a cryptocurrency asset.

Recently, a plethora of blockchain networks have emerged to facilitate many types of useful transactions, such as supply chain management, peer-to-peer transactions, and the like. One notorious use of blockchains is for cryptocurrency systems.

With the proliferation of different blockchain networks, a need has arisen for the ability to exchange data between blockchains. Such data may be used to enable transactions between blockchains as just one example. However, while various mechanisms have been devised to “bridge” blockchains, many technical problems exist with conventional mechanisms.

For example, in the context of cryptocurrency and other asset transactions between blockchains, existing bridges present a high-value target for wrongdoers (e.g., hackers) to attempt to steal an asset in transition between the bridged blockchains, or an asset that has been bridged between blockchains and is locked up for an extended period of time. As another example, bridges can lead to asset fragmentation across blockchains.

Accordingly, there is a need for improved systems and methods for bridging blockchains.

### SUMMARY

Certain aspects provide a method for performing a blockchain-based transaction, comprising: executing a first process on a first blockchain, including: causing a first amount of cryptocurrency to be burned on the first blockchain according to a burn operation; formatting a message to include one or more details of the burn operation; and emitting the message to an event log associated with the first blockchain; requesting an attestation from an attestation service based on a hash of the message emitted to the event log; receiving the attestation from the attestation service; and executing a second process on a second blockchain, including: providing the message and the attestation to the second blockchain; and causing a second amount of cryptocurrency to be minted on the second blockchain based on the message.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 depicts an example architecture for bridging between source and destination blockchains.

FIG. 2 depicts a method for performing a blockchain-based transaction.

FIG. 3 depicts an example processing system configured for performing various aspects of the methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for bridging blockchains.

In particular, aspects described herein relate to an improved blockchain bridge that enables bridging of native assets (e.g., cryptocurrency tokens) across different blockchains. Beneficially, the blockchain bridges described herein offer many technical benefits over existing bridging mechanisms.

For example, the blockchain bridges described herein enable improved security compared to existing bridging mechanisms, such as “lock and wrap” bridges. With a typical lock and wrap bridge, all bridged tokens are locked in a single smart contract on the source blockchain. This leads to a high-value target for hackers to attempt to find a vulnerability on the source smart contract (or potentially on the destination smart contract as well to trick it into sending a bad burn message) because doing so would allow them to withdraw the tokens and effectively render the wrapped token worthless.

Further, the blockchain bridges described herein lead to decreased liquidity fragmentation. For example, the blockchain bridges described herein enable simpler and more efficient transfer of native assets to different blockchains, where previously such asset transactions would have had to go through a centralized exchange, a decentralized exchange, a liquidity pool, or the like.

Furthermore, the blockchain bridges described herein enable fast and computationally efficient mechanisms for moving assets from one blockchain to another. For example, the blockchain bridges described herein eliminates the complexity and use of wrapped tokens. As above, a lock and wrap bridge makes use of wrapped tokens on destination blockchains, which are essentially non-native representations of the native tokens. In most cases the wrapped tokens have 1:1 backing of native tokens on source chains. But in cases of hacks, vulnerabilities, bugs, compromised admins, etc., these wrapped tokens can become unbacked and effectively worthless. Because the blockchain bridges described herein do not use wrapped tokens, these issues are completely avoided.

Accordingly, these improved blockchain bridges are a technical solution to technical problems associated with current bridges and their associated asset movement mechanisms.

### Brief Background on Blockchain Bridging

Different blockchain networks generally do not have a native ability to communicate with each other. This limitation has many root causes, such as each blockchain network having its own set of rules, governance mechanisms, protocols, consensus mechanisms, native assets, and the like.

Blockchain bridges are generally a mechanism for connecting and allowing data exchange between different blockchain networks, such as different cryptocurrency blockchain networks. For example, a bridge between two cryptocurrency blockchain networks enables the transfer of cryptocurrency assets between the networks. Accordingly, blockchain bridges enable interoperability between otherwise vertically integrated blockchain network systems. When bridging between blockchain networks, the blockchain network that is the data source (e.g., the initiator of a transaction) is often referred to as the source blockchain (or source chain), and the blockchain that is the data destination (or sink) is often referred to as the destination blockchain (or destination chain).

An important aspect for blockchain bridges is the mechanism used for establishing trust between the bridged blockchain networks. Natively, a first and second blockchain do not know of each other and thus activity on one blockchain from the perspective of the other is likewise unknown because it is “off-chain.” Blockchain bridges employ different trust mechanisms for establishing trust between blockchain networks, which enables interactivity between the blockchain networks.

For example, blockchain bridges may utilize so-called “trusted systems” and “trustless systems.” Relatedly, blockchain bridges that rely on trusted systems may be referred to as trusted blockchain bridges, while blockchain bridges that rely on trustless systems may be referred to as trustless blockchain bridges.

Trusted blockchain bridges generally rely on a trusted third party (or “trust authority”) to verify activity (e.g., an asset movement) between the bridged blockchain networks. Consequently, a party to the transaction must trust the third party to complete the cross-bridge transaction without issue, such as moving an asset from one blockchain network to another.

Trustless blockchain bridges, on the other hand, do not rely on a trusted third party to enable cross-bridge transactions. Instead, such blockchain bridges may use automated means, such as smart contracts and algorithms, to enable the transactions.

Another aspect of blockchain bridges is the type(s) of blockchains they connect. For example, a “layer 1 bridge” may connect two layer 1 (or “L1”) blockchain networks to one another, where a Layer 1 blockchain generally describes a main blockchain architecture. As another example, a “layer 1/layer 2 bridge” may connect an L1 blockchain network to a layer 2 (or “L2”) blockchain network. Similarly, a “L2/L2 bridge” may connect two L2 blockchain networks. These are just some examples, and others exist.

Yet another aspect of blockchain bridges is the mechanism they use to move assets between blockchain networks. For example, so-called “lock and mint” bridges lock assets on a source blockchain and mint assets on the destination blockchain chain. As another example, so-called “burn and mint” bridges burn assets on the source blockchain and mint assets on the destination blockchain. As a further example, so-called “atomic swap bridges” swap assets on the source blockchain for assets on the destination blockchain.

### Example Architecture for Bridging Between Blockchains

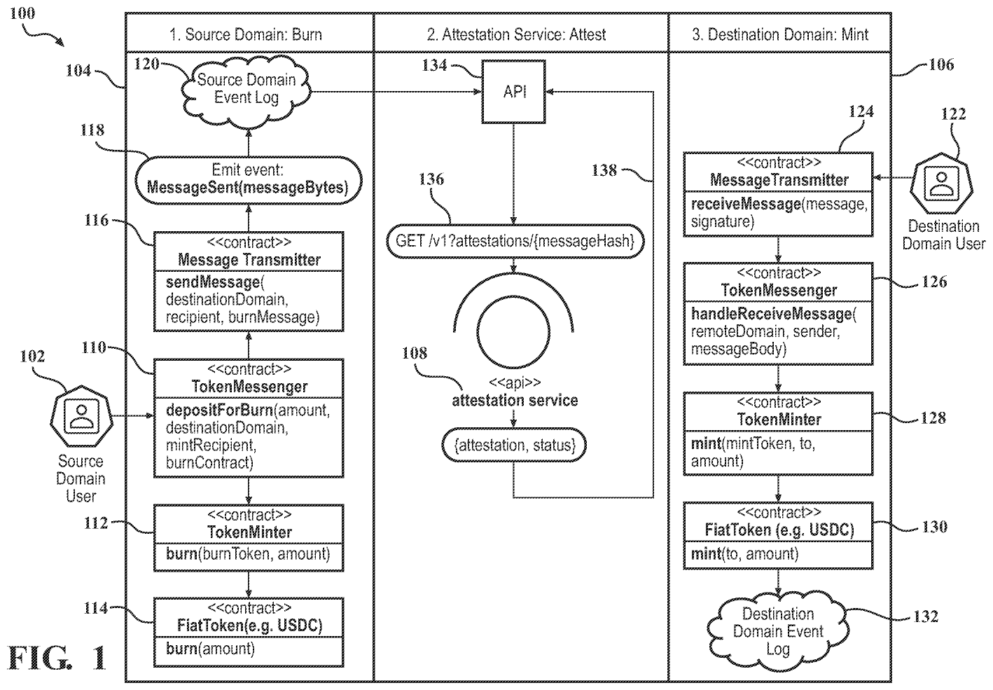

FIG. 1 depicts an example architecture 100 for bridging between source and destination blockchains, for example, to perform a burn and mint operation.

In particular, FIG. 1 depicts a source domain user 102 performing a burn and mint bridging operation between a source blockchain 104 and a destination blockchain 106. In the depicted example, the bridging operation is used for moving an asset (a cryptocurrency token in this example) from the source blockchain 104 to the destination blockchain 106. In some examples, the asset may be a stable coin, such as a USD Coin (“USDC”).

Initially, a source domain smart contract 110 is called on source blockchain 104 by source domain user 102 that is intended to move the token from source blockchain 104 to destination blockchain 106. Source domain smart contract 110 causes a token minter component 112 to burn the user's token(s) at 114. Source domain smart contract 110 further causes message transmitter component 116 to create a formatted message intended for destination blockchain 106. In some examples, the formatted message emits as an event at 118, such as a smart contract event, or other similar data log, which is stored in source domain event log 120.

In the depicted example, source domain smart contract at 110 includes various information elements, including a destination domain for the token, an amount of token to burn in the source domain, a mint recipient, and a burn contract.

In the depicted example, message transmitter component 116 receives various information elements based on source domain smart contract 110, including the destination domain for the token, the mint recipient for the message, and a burn message. In some aspects, the burn message is formatted data that when decoded by the destination blockchain smart contract (e.g., 126), indicates what should be done on the destination blockchain. For example, the burn message may indicate that 10 tokens of a cryptocurrency were burned on the source blockchain so 10 tokens of the cryptocurrency should be minted on the destination blockchain.

The attestation service 108 serves as a trusted, off-chain intermediary between source blockchain 104 and a destination blockchain 106 in the depicted example.

In the depicted example, source domain user 102 takes a message hash from the source domain event log 120 and requests an attestation (e.g., a signature) from attestation service 108 with that message hash, as depicted at 136, via API 134. Attestation service 108 signs the messages with its private keys to provide proof to destination blockchain 106 that the event happened (e.g., the burn event at 114) and provides the signature to API 134 at 138. Source domain user 102 then provides the signature to destination domain smart contract 126 for proof that the burn happened at 114.

Destination domain user 122, which in some cases is the same as source domain user 102, then calls the destination domain smart contract 126 on destination blockchain 106 based on the message received by message transmitter component 124 (which may alternatively be referred to as a message receiver component) from source domain smart contract 110 and the signature from attestation service 108. Destination domain smart contract 126 verifies the message and signature received by message transmitter component 124 originated with attestation service 108 by comparing the private key used to sign and send the message with a public key stored in destination domain smart contract 126. The message received by message transmitter component 124 provides proof of the burn event at 114 because only attestation service 108 has the private key corresponding to the public key stored in destination domain smart contract 126 needed to sign the message. Beneficially, the signature from attestation service 108 provides proof for destination domain smart contract 126 to cause a token minter component 128 to mint the equivalent amount of token(s) at 130 on destination blockchain 106 and send them to a given address. The minting of new tokens on destination blockchain 106 is then logged in destination domain event log 132.

In the depicted example, message transmitter component 124 receives various information elements based on source domain smart contract 110, including a message and signature created by attestation service 108.

In the depicted example, destination domain smart contract 126 includes various information elements, including a remote domain associated with the message, a sender of the message, and a message body, which includes an amount of token to mint on destination blockchain 106. Note that the remote domain associated with the message may refer to the source domain, but may be referred to as remote because the bridge itself is not considered a source.

Thus, FIG. 1 depicts an example of a burn and mint bridge between source blockchain 104 and a destination blockchain 106.

### Example Methods for Bridging Between Blockchains

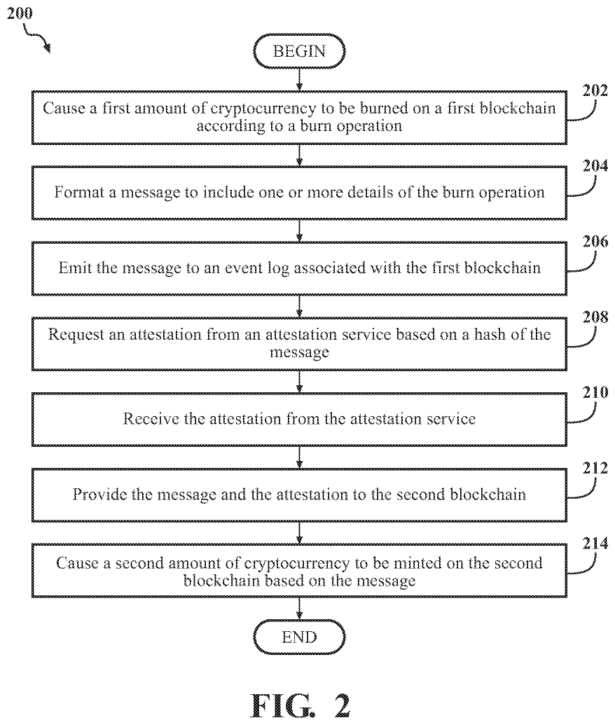

FIG. 2 depicts a method 200 for bridging between blockchains, for example, to perform a burn and mint operation.

Method 200 begins at step 202 with causing a first amount of cryptocurrency to be burned on the first blockchain according to a burn operation, such as depicted at 114 with respect to token minter component 112 in FIG. 1.

Method 200 then proceeds to step 204 with formatting a message to include one or more details of the burn operation, such as depicted by message transmitter component 116 in FIG. 1.

In some aspects, the message comprises a smart contract event. In some aspects, the message further comprises one or more of: an indication of the first blockchain; a sender; and an indication of the second amount of cryptocurrency. In some aspects, the message further comprises one or more of: an indication of the second blockchain; a recipient; and a burn contract defining the burn operation. In some aspects, the one or more details of the burn operation comprise at least an indication of the first amount of cryptocurrency.

Method 200 then proceeds to step 206 with emitting the message to an event log associated with the first blockchain, such as depicted at 118 with respect to source domain event log 120 in FIG. 1.

In some aspects, steps 202-206 refer to a first process defined by a first smart contract.

Method 200 then proceeds to step 208 with requesting an attestation from an attestation service based on a hash of the message emitted to the event log, such as depicted at 136 with respect to attestation service 108 in FIG. 1.

Method 200 then proceeds to step 210 with receiving the attestation from the attestation service, such as depicted at 138 in FIG. 1. In some aspects, the attestation comprises a signature.

Method 200 then proceeds to step 212 with providing the message and the attestation to the second blockchain, such as depicted at 124 in FIG. 1.

Method 200 then proceeds to step 214 with causing a second amount of cryptocurrency to be minted on the second blockchain based on the message, such as depicted at 130 with respect to token minter component 128 in FIG. 1.

In some aspects, steps 212 and 214 refer to a second process that is defined by a second smart contract.

In some aspects, method 200 further comprises sending the second amount of cryptocurrency to a destination address included within the message, such as depicted at 130 in FIG. 1.

In some aspects, the first amount of cryptocurrency is the same as the second amount of cryptocurrency. In some aspects, the first amount of cryptocurrency has an equivalent value to the second amount of cryptocurrency.

In some aspects, method 200 further comprises verifying the attestation is based on an expected public key.

Note that FIG. 2 is just one example of a method and other methods including fewer, additional, or alternative steps are possible consistent with this disclosure.

### Example Processing System for Bridging Between Blockchains

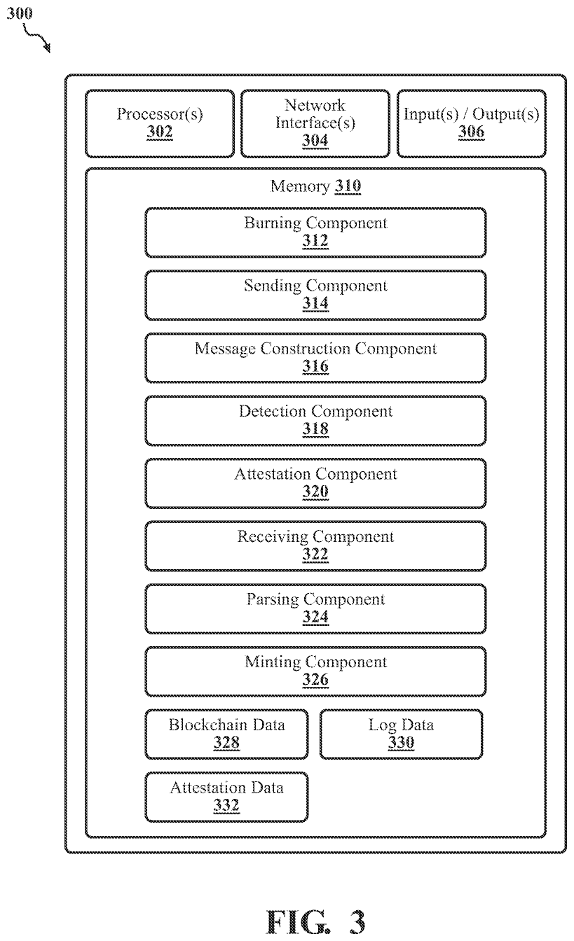

FIG. 3 depicts an example processing system configured for performing various aspects of the methods described herein, including method 200 discussed above with respect to FIG. 2.

Processing system 300 includes one or more processors 302. Generally, processor(s) 302 may be configured to execute computer-executable instructions (e.g., software code) to perform various functions, as described herein.

Processing system 300 further includes a network interface(s) 304, which generally provides data access to any sort of data network, including personal area networks (PANs), local area networks (LANs), wide area networks (WANs), the Internet, and the like. In some cases, network interface(s) 304 provide access to blockchain networks, including source and destination blockchain networks, such as described above.

Processing system 300 further includes input(s) and output(s) 306, which generally provide means for providing data to and from processing system 300, such as via connection to computing device peripherals, including user interface peripherals.

Processing system further includes a memory 310 configured to store various types of components and data.

In this example, memory 310 includes a burning component 312, a sending component 314, a message construction component 316, a detection component 318, an attestation (or signing) component 320, a receiving component 322, a parsing component 324, a minting component 326, blockchain data 328, log data 330, and attestation data 332.

Processing system 300 may be implemented in various ways. For example, processing system 300 may be implemented within on-site, remote, or cloud-based processing equipment.

Note that while depicted as a single processing system in FIG. 3, aspects of processing system 300 may be distributed among a plurality of processing systems. For example, each of the steps of method 200 described above with respect to FIG. 2 may be performed on a separate processing system (not depicted).

Processing system 300 is just one example, and other configurations are possible. For example, in alternative embodiments, aspects described with respect to processing system 300 may be omitted, added, or substituted for alternative aspects.

### Example Clauses

Implementation examples are described in the following numbered clauses:

Clause 1: A method for performing a blockchain-based transaction, comprising: executing a first process on a first blockchain, including: causing a first amount of cryptocurrency to be burned on the first blockchain according to a burn operation; formatting a message to include one or more details of the burn operation; and emitting the message to an event log associated with the first blockchain; requesting an attestation from an attestation service based on a hash of the message emitted to the event log; receiving the attestation from the attestation service; executing a second process on a second blockchain, including: providing the message and the attestation to the second blockchain; and causing a second amount of cryptocurrency to be minted on the second blockchain based on the message.

Clause 2: The method of Clause 1, wherein the one or more details of the burn operation comprise at least an indication of the first amount of cryptocurrency.

Clause 3: The method of any one of Clauses 1-2, wherein the message further comprises one or more of: an indication of the second blockchain; a recipient; and a burn contract defining the burn operation.

Clause 4: The method of any one of Clauses 1-3, wherein the first process is defined by a first smart contract.

Clause 5: The method of any one of Clauses 1-4, wherein the message comprises a smart contract event.

Clause 6: The method of any one of Clauses 1-5, further comprising sending the second amount of cryptocurrency to a destination address included within the message.

Clause 7: The method of any one of Clauses 1-6, wherein the first amount of cryptocurrency is the same as the second amount of cryptocurrency.

Clause 8: The method of any one of Clauses 1-6, wherein the first amount of cryptocurrency has an equivalent value to the second amount of cryptocurrency.

Clause 9: The method of any one of Clauses 1-8, wherein the message further comprises one or more of: an indication of the first blockchain; a sender; and an indication of the second amount of cryptocurrency.

Clause 10: The method of any one of Clauses 1-9, wherein the second process is defined by a second smart contract.

Clause 11: The method of any one of Clauses 1-10, further comprising verifying the attestation is based on an expected public key.

Clause 12: The method of any one of Clauses 1-11, wherein the attestation comprises a signature.

Clause 13: A processing system, comprising: a memory comprising computer-executable instructions; and a processor configured to execute the computer-executable instructions and cause the processing system to perform a method in accordance with any one of Clauses 1-12.

Clause 14: A processing system, comprising means for performing a method in accordance with any one of Clauses 1-10.

Clause 15: A non-transitory computer-readable medium comprising computer-executable instructions that, when executed by a processor of a processing system, cause the processing system to perform a method in accordance with any one of Clauses 1-12.

Clause 16: A computer program product embodied on a computer-readable storage medium comprising code for performing a method in accordance with any one of Clauses 1-12.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for performing a blockchain-based transaction, comprising:
executing a first process on a first blockchain, including:
causing a first amount of cryptocurrency to be burned on the first blockchain according to a burn operation;
formatting a message to include one or more details of the burn operation; and
emitting the message to an event log associated with the first blockchain;
requesting an attestation from an attestation service based on a hash of the message emitted to the event log;
receiving the attestation from the attestation service; and
executing a second process on a second blockchain, including:
providing the message and the attestation to the second blockchain; and
causing a second amount of cryptocurrency to be minted on the second blockchain based on the message.

2. The method of claim 1, wherein the one or more details of the burn operation comprise at least an indication of the first amount of cryptocurrency.

3. The method of claim 1, wherein the message further comprises one or more of:
an indication of the second blockchain;
a recipient; and
a burn contract defining the burn operation.

4. The method of claim 1, wherein the first process is defined by a first smart contract.

5. The method of claim 1, wherein the message comprises a smart contract event.

6. The method of claim 1, further comprising sending the second amount of cryptocurrency to a destination address included within the message.

7. The method of claim 1, wherein the first amount of cryptocurrency is the same as the second amount of cryptocurrency.

8. The method of claim 1, wherein the first amount of cryptocurrency has an equivalent value to the second amount of cryptocurrency.

9. The method of claim 1, wherein the message further comprises one or more of:
an indication of the first blockchain;
a sender; and
an indication of the second amount of cryptocurrency.

10. The method of claim 1, wherein the second process is defined by a second smart contract.

11. The method of claim 1, further comprising verifying the attestation is based on an expected public key.

12. The method of claim 1, wherein the attestation comprises a signature.

13. A processing system, comprising: a memory comprising computer-executable instructions; and a processor configured to execute the computer-executable instructions and cause the processing system to:
execute a first process on a first blockchain, including:
cause a first amount of cryptocurrency to be burned on the first blockchain according to a burn operation;
format a message to include one or more details of the burn operation; and
emit the message to an event log associated with the first blockchain;
request an attestation from an attestation service based on a hash of the message emitted to the event log;
receive the attestation from the attestation service; and
execute a second process on a second blockchain, including:
provide the message and the attestation to the second blockchain; and
cause a second amount of cryptocurrency to be minted on the second blockchain based on the message.

14. The processing system of claim 13, wherein the one or more details of the burn operation comprise at least an indication of the first amount of cryptocurrency.

15. The processing system of claim 13, wherein the message further comprises one or more of:
an indication of the second blockchain;
a recipient; and
a burn contract defining the burn operation.

16. The processing system of claim 13, wherein the one or more details of the burn operation comprise at least an indication of the first amount of cryptocurrency.

17. The processing system of claim 13, wherein the processor is further configured to send the second amount of cryptocurrency to a destination address included within the message.

18. The processing system of claim 13, wherein the message further comprises one or more of:
an indication of the first blockchain;
a sender; and
an indication of the second amount of cryptocurrency.

19. The processing system of claim 13, wherein the processor is further configured to verify the attestation is based on an expected public key.

20. A non-transitory computer-readable medium comprising computer-executable instructions that, when executed by a processor of a processing system, cause the processing system to:
execute a first process on a first blockchain, including:
causing a first amount of cryptocurrency to be burned on the first blockchain according to a burn operation;
formatting a message to include one or more details of the burn operation; and
emitting the message to an event log associated with the first blockchain;
request an attestation from an attestation service based on a hash of the message emitted to the event log;
receive the attestation from the attestation service; and
execute a second process on a second blockchain, including:
providing the message and the attestation to the second blockchain; and
causing a second amount of cryptocurrency to be minted on the second blockchain based on the message.
